(19) United States
(12) Patent Application Publication
(10) Pub. No.: US 2008/0122651 A1
(43) Pub. Date: May 29, 2008

(54) Wireless data exchange

(75) Inventors: Gerhard Niederfeld, Essen (DE); Bernd Schulte, Herne (DE); Klaus Volbert, Essen (DE)

Correspondence Address: K.F. ROSS P.C., 5683 RIVERDALE AVENUE, SUITE 203 BOX 900, BRONX, NY, 10471-0900, US

(73) Assignee: Shared Services GmbH

(21) Appl. No.: 11/985,053

(22) Filed: Nov. 13, 2007

(30) Foreign Application Priority Data
Nov. 14, 2006 (DE) 102006053822.6

(51) Int. Cl. G08C 15/12

(52) U.S. Cl. 340/870.03

(57) ABSTRACT

Data is exchanged by periodically broadcasting at predetermined first short intervals from each of a plurality of data sources on a radio channel a communication-initiating radio signal indicating that the respective source has data ready for transfer. The radio channel is monitored by that can transmit to one of the sources a signal triggering data exchange, whereby subsequently the respective data is transmitted from the one source to the receiver. Thereafter periodic broadcast of the communication-initiating radio signal from the one source is suspended for a predetermined long interval substantially greater than the short interval.

### FIELD OF THE INVENTION

The present invention relates to wireless data exchange. More particularly this invention concerns wireless data exchange from a plurality of data sources to at least one receiver and where communications-initiating radio signals are broadcast from the data sources largely periodically on a communication channel designated for this purpose and a receiver after reception of a communication-initiating radio signal communicates with one of the data sources in order at least to exchange data with the data source.

### BACKGROUND OF THE INVENTION

Such data-exchange methods are fundamentally known in the prior art and are used for instance in the framework of reading out consumption of any type, e.g. electrical or heating energy consumption, where in the case of the data sources this equipment can be readers that registers the consumption of such resources and store it for periodic retrieval. For instance, the data sources can thus be so-called heating cost distributors that register heat consumption for a year and for instance store it on a closing date. The stored closing date values and also any current consumption values, and where necessary also additional information, can then be retrieved from such heating cost distributors, for which a corresponding receiving device can be provided.

The above-described field of use is understood to be merely an example and does not limit the field of use of the invention. Fundamentally the inventive method can be used anywhere that a plurality of data sources make their data available to a receiver by a wireless radio link.

In the framework of the present inventive description, a receiver is understood to be a device that is able both to receive the communication-initiating radio signals and also the data that is broadcast from the data sources. A receiver of such radio signals and data is also itself able to act as a transmitter in order to perform the communication with the data sources, e.g. using a specific radio protocol. The essential field of application is the reception of stored or collected data from the data sources so that despite the fact that this equipment also has transmitting properties, in the framework of the invention it is known as a receiver.

With respect to the field of application of the heating cost determination, such a receiver can be for example a mobile device that is carried through a property by a service technician or a person for the purpose of reading off information, for instance near a closing date such as the last day of the year in order to retrieve from the data sources the stored closing date values. In this above-described field of application, which does not limit the invention, by receiving a communication-initiating radio signal from one of the numerous data sources present in the property the receiver perceives that data are available for retrieval at one of the pertinent data sources. Consequently, after reception of a communication-initiating radio signal, by transmitting a response message the receiver can inform the data source that the receiver is ready to receive the data so that the data source transmits the appropriate data and the receiver can receive the appropriate data.

All of the features that are described in the framework of this specification and using the example of heating cost distributors apply in general for any type of data sources and receivers.

In one such manner of performing a data exchange among a plurality of data sources, for instance heating cost distributors in a property, using one receiver, the problem is known that there can be collisions between the communications-initiating radio signals of the plurality of data sources.

The reason for this is that the individual data sources, in particular together with at least one receiver, form a radio network and normally each periodically transmits communications-initiating radio signals in order to notify any receiver located in the receiving area that a data source is available for a data exchange.

Due to the fact that a specific communication channel is provided, at least for the communications-initiating radio signals, there are frequently collisions on this communication channel because all of the data sources periodically transmit their communications-initiating radio signals on the single communication channel that is provided for this purpose at this query time, which means that any receiver present in the receiving area cannot receive a receiving communications-initiating radio signal and thus also cannot make contact with the data source, or due to a collision is not even able to receive.

It is furthermore known from the prior art that data sources from which a communications-initiating radio signal has already been received by one receiver and from which a data exchange to the receiver has already taken place continue after the completed data exchange to periodically broadcast the radio signals despite the fact that no new data for transmission are available, with the result that the radio signals of these specific already queried data sources interfere with communication with as yet unqueried data sources, in particular, through collisions.

### OBJECTS OF THE INVENTION

It is therefore an object of the present invention to provide an improved wireless data-exchange system.

Another object is the provision of such an improved wireless data-exchange system that overcomes the above-given disadvantages, in particular where the risk of collisions can be reduced, thereby enabling a simpler, more reliable and less time-consuming data exchange.

### SUMMARY OF THE INVENTION

Data is exchanged according to the invention by periodically broadcasting at predetermined first short intervals from each of a plurality of data sources on a radio channel a communication-initiating radio signal indicating that the respective source has data ready for transfer. The radio channel is monitored by that can transmit to one of the sources a signal triggering data exchange, whereby subsequently the respective data is transmitted from the one source to the receiver. In accordance with the invention thereafter periodic broadcast of the communication-initiating radio signal from the one source is suspended for a predetermined long interval substantially greater than the short interval.

In other words, after an completed exchange of data, the subsequent transmission of periodic communications-initiating radio signals on the communications channel designated for this purpose is interrupted at least for a predetermined time interval.

The fundamental core idea of the embodiment of the invention is that the receiver, after a collision-free reception of a communications-initiating radio signal, exchanges data with the data source that transmitted this radio signal, and that subsequent to this exchange the already queried data source does not continue to disturb communication with the remaining data sources.

The reason for this is that after the successful query on the communications channel provided for the broadcast of the communications-initiating radio signals, and also as necessary for the broadcast of the data, no further communications-initiating radio signals are transmitted by the queried data source for the above-described predetermined time interval.

For this reason, a queried data source cannot continue, after the data query, to negatively influence the broadcast of communications-initiating radio signals from other still unqueried data source. As a result, as the query of data sources proceeds after the collision-free reception of a communications-initiating radio signal, the risk of collisions is increasingly reduced since as the queries are completed fewer and fewer data sources are available which have not yet been queried and which continue to periodically broadcast their communications-initiating radio signals intended for the query until finally only one data source is available which alone periodically broadcasts its radio signals, until this data source also has been queried about available data.

Provision can thus be made whereby the predetermined time interval is allocated generously enough that within this time interval it can normally be expected that the query of all available data sources can be completely concluded. This time interval can, for instance, entail multiple minutes, hours, or even an entire day.

In addition to the fact that the interruption of the broadcast of communications-initiating radio signals for this time interval enables the collision rate to be reduced, the method can also have the advantage that in addition during this time interval energy is saved if specifically this type of data source not only interrupts the broadcast of radio signals for the communications channel previously designated for this purpose, but overall interrupts completely the broadcast of communications-initiating radio signals.

In a possible embodiment of the invention, provision can be made whereby after the broadcast of a communications-initiating radio signal a data source automatically switches over to receive, in particular, for a time-limited receive-mode window provided for this purpose, in order to determine whether a receiver possibly present within the reception area is responding to the broadcast radio signal. If this is the case, and if the broadcasting data source and the receiver can thus synchronize to each other, then the data exchange can take place, for instance based on a provided protocol.

In this case, provision can be made in a possible embodiment whereby the exchange of data of the data source, which data is intended for transmission and possibly stored, takes place on the same communications channel as the broadcast of the communications-initiating radio signals.

In general, further provision can be made whereby in addition to the exchange of data intended for the exchange, such as, for instance, consumption data, during this opportunity other information which is available in a data source and is only transmitted upon request may also be actively queried by a receiver. For instance, this may involve status or statistical information. Provision can also be made whereby, in particular during this opportunity, data is sent by the receiver to a data source, such as, for instance, for programming closing dates or activating a test program.

In another embodiment, provision can be made whereby an additional communication takes place on another communications channel, such as analogously to the above after a data transmission, and/or the data transmission itself takes place between the data source and a receiver.

For instance, provision can be made whereby all data sources first broadcast the communications-initiating radio signals on a specific communications channel, and subsequently after a successful reception of such a radio signal the data exchange itself then takes place on another communications channel, one provided only for the data transmission.

In terms of interrupting the broadcast of periodic communications-initiating radio signals for purposes of the invention, provision can also be made in an embodiment whereby a data source, in particular after a successful data transmission of stored data to a receiver, interrupts the subsequent broadcast of periodic radio signals on the designated communications channel, then continues the broadcast on another communications channel or on another additional communications channel designated for this purpose. In this regard, provision can be made in particular whereby the other, or additional, communications channel designated for this purpose can in turn be the same for all data sources of the radio system—which in an embodiment means that at a given instant when a receiving device is deployed to query the data sources this receiving device listens for communications-initiating radio signals on a specific first communications channel until all data sources have been queried, and for a subsequent later query, for example after one year, the query takes place on the other communications channel, since within the scope of the inventive method all data sources have switched from the first to the second communications channel after the successful transmission of data.

Similar provision can be made whereby the switch to another channel, either only to exchange data and/or to continue the periodic broadcast of radio signals, takes place in time-limited fashion, with the result that after the lapse of a predetermined time interval for this switch the data source then resumes broadcast of the communications-initiating radio signals on the communications channel originally designated for this purpose.

Thus, provision can accordingly be made whereby between communications provided for querying data from data sources a simple or multiple, in particular, a two-fold switch of the channel takes place for the broadcast of the periodic radio signals between two communications channels designated for this purpose.

In all possible embodiments of the invention, provision can be made whereby the suspension of communication, in particular, the suspension of communications-initiating radio signals and/or the switch-over to another communications channel, is initiated by a command which is transmitted by a receiver to a data source before, or also after, the data transmission.

Optionally, provision can be made in another embodiment whereby a data source automatically switches to another communications channel, either to continue the periodic broadcast of the radio signals and/or to broadcast the relevant data, as soon as it is notified by a receiver that an originally broadcast radio signal has been received successfully, in particular collision-free.

In regard to the above-referenced method variants, it must be remembered that the data sources can be formed, for instance, by equipment for consumption data acquisition, such as, for instance, heating cost distributors, gas meters, electric meters, water meters or heat meters, or special communications modules for consumption meters. Notwithstanding this designation of the field of application of consumption data acquisition, the invention is not limited to this field of application.

In principle, provision can be made, for instance, whereby the data sources are formed by any other equipment which provides data for broadcast to a receiver, where this receiver can, as mentioned above, also have transmitting properties. For instance, in another application this may also involve equipment for issuing alarms, in particular, smoke or fire alarms. This may in all cases of application also involve any types of data that are collected during the operation of a data source. In addition to the above-referenced uses, status information or any other desired data for transmission can thus be held in readiness. Specifically in the case of equipment for issuing alarms, provision can be made whereby these are periodically inspected, for example once a year in terms of their function, and as necessary status information, a problem report, issued alarm reports, or other information is read out as data by an appropriate receiver.

### BRIEF DESCRIPTION OF THE DRAWING

The above and other objects, features, and advantages will become more readily apparent from the following description, reference being made to the accompanying drawing in which:

FIG. 1 is a diagram illustrating a variant of the method in which the broadcast of communications-initiating radio signals is completely interrupted for a predetermined time interval while maintaining the communications channel;

FIG. 2 shows a variant of the method in which the communications channel is switched only for the broadcast of data;

FIG. 3 shows a variant of the method in which broadcasting of the communications-initiating radio signals is continued for a specified time on another channel; and

FIG. 4 shows a variant of the method in which switching of the specific channel is effected after a completed data query until the next data query.

### SPECIFIC DESCRIPTION

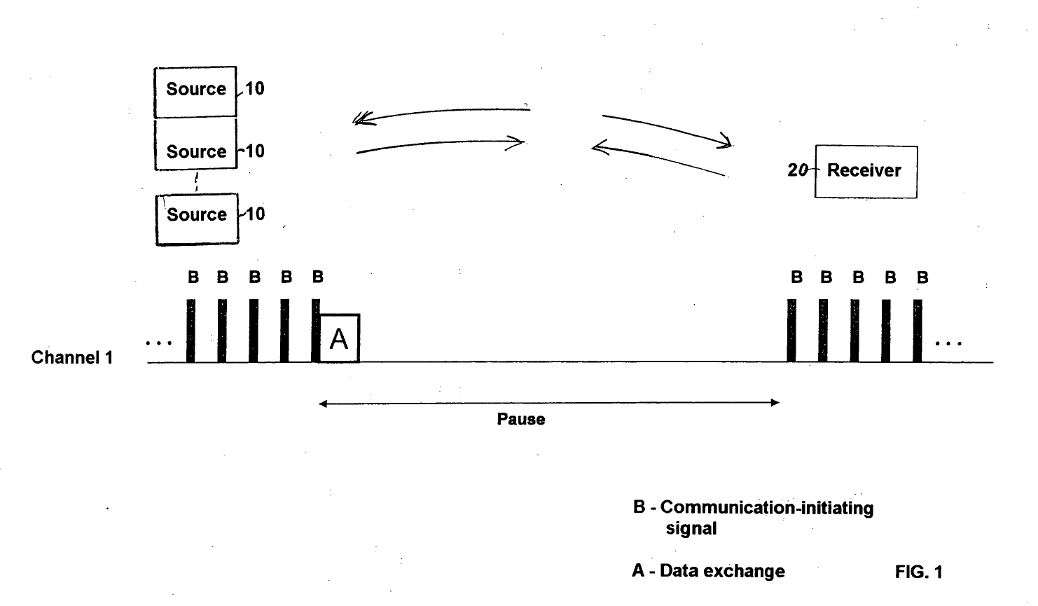

FIG. 1 illustrates an embodiment in which for purposes of illustration only the communication of one data source 10 out of a plurality of data sources 10 is shown. Seen here is a single channel 1 on which the data source 10 periodically broadcasts communications-initiating radio signals B. A receiver 20 which can receive such a communications-initiating radio signal can be located within the reception area of such a data source 10.

In the case of FIG. 1, it is assumed that after broadcasting a five communications-initiating radio signals B, the receiver 20 acknowledges the reception of the last radio signal and initiates a data exchange, shown here at A. After the completed data exchange, the broadcast of periodic communications-initiating radio signals B is interrupted for a predetermined interval equal to a multiple of the time between standard such broadcasts, so as to preclude collisions with other radio signals from other data sources 10 for the duration of the predetermined pause. After the pause has expired, the data source 10 in question once again continues the periodic broadcast of radio signals on the channel designated for this purpose so as to indicate readiness for additional communications.

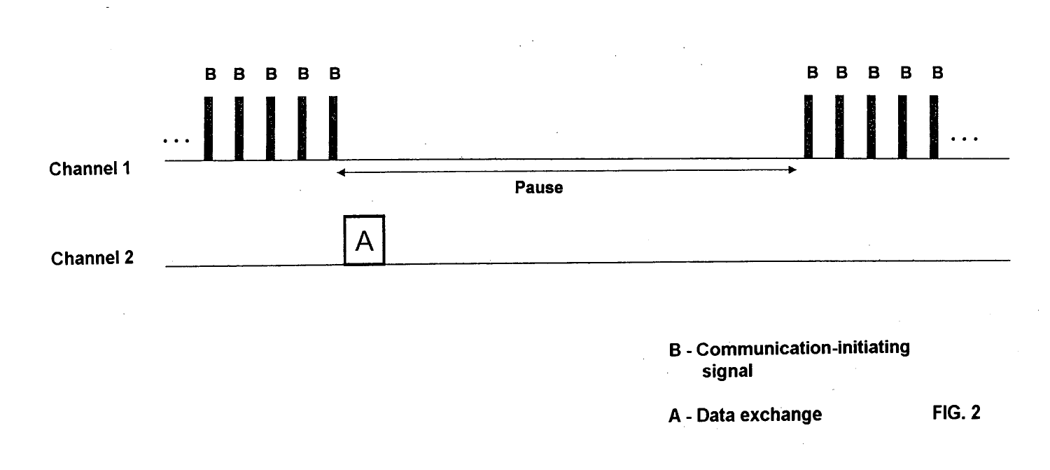

FIG. 2 illustrates essentially the same situation as in FIG. 1. Here however, provision is made here according to the invention such that after successfully receiving a communications-initiating radio signal B, the transmission of the stored data of the data source 10 is effected on a second channel 2. Channel separation is provided here for the broadcast of the communications-initiating radio signals and for the broadcast of the actual relevant data. Once again, provision is made here whereby, after a pause for the interruption, the periodic broadcast of the communications-initiating radio signals is continued on the same original channel 1.

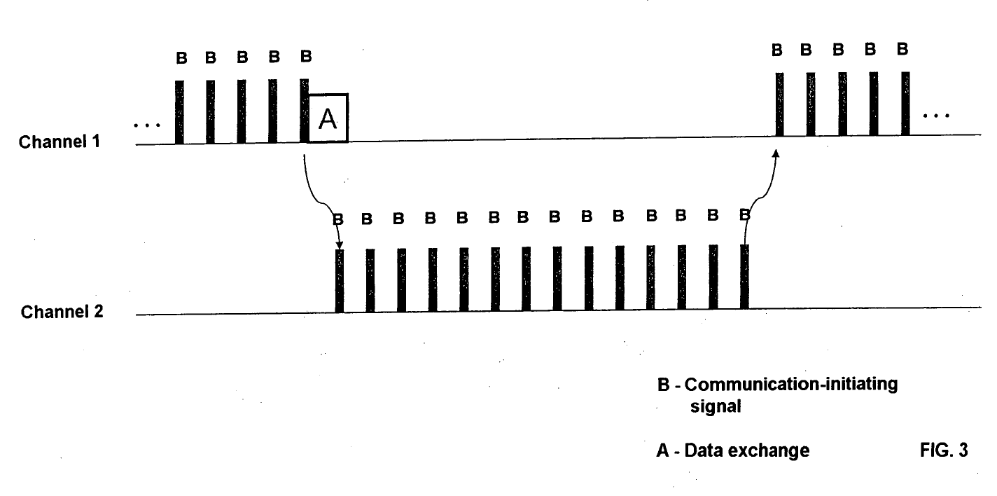

FIG. 3 shows another alternative embodiment of the inventive method in which provision is made whereby the data sources 10 first periodically broadcast the radio signals for communication initiation on a channel 1. After successful reception of such a radio signal, the data can then be exchanged within the time window A with a receiver 20 on the same channel, or as necessary on another channel, where provision is then made whereby for a specified pause interval the queried data source 10 continues the subsequent broadcast of periodically successive communications-initiating radio signals B on another channel 2 designated for this purpose.

This approach ensures that the subsequent, not-yet-queried data sources 10 continue to be able to broadcast their radio signals on channel 1 without having to fear collisions with radio signals that are being broadcast by already queried data sources 10. During broadcast of the radio signals on channel 2, additional provision can be made whereby contact is once again made with the one or the other receiver 20 to the queried data source 10 over channel 2, a case not shown here, however.

After the pause interval has lapsed, on the other hand, the periodic broadcast of communications-initiating radio signals is continued on channel 1 originally designated for this purpose, while the broadcast is discontinued on alternative channel 2.

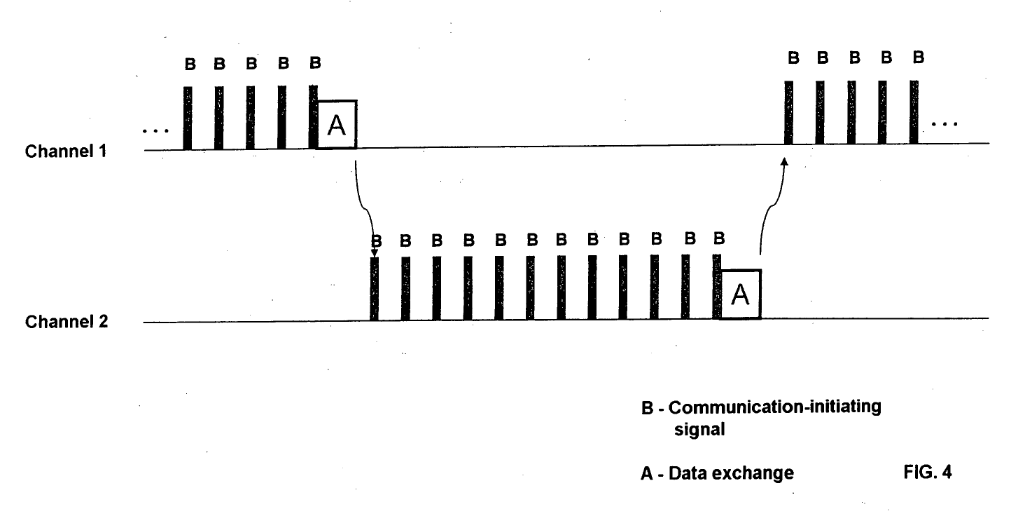

FIG. 4 shows another alternative embodiment in which at a first query instant for the data all data sources 10 communicate communications-initiating radio signals B, as well as preferably also to-be-broadcast data A, only on a first channel 1 designated for this purpose.

After a completed query of data from a data source 10, this data source 10 interrupts the subsequent broadcast of communications-initiating radio signals B on channel 1 originally designated for this purpose, and continues these on alternative channel 2. This can be the case for all data sources 10 which are queried by a receiver 20 within the scope of the inventive method, such that after the complete query of all data sources 10 available in the system all data sources 10 then broadcast communications-initiating radio signals B on second alternative channel 2, with the result that in response to a later repeat query, e.g., after the lapse of measurement time period—for consumption data acquisition equipment, e.g., after one year—the same data sources 10 are queried by a receiving device on second alternative channel 2, where the inventive method is again utilized and where provision can then be made, where after the repeat query of the data the broadcast of communications-initiating radio signals B is further continued on original channel 1, or again even on a yet another, e.g., third channel. Provision can accordingly be made here whereby after the respective query periods have expired the data sources 10 of the radio system always switch back and forth between two, or even more, radio channels to broadcast the communications-initiating radio signals B and/or data to be transmitted A.

After switching between only two alternative channels, provision can be also made whereby after each completed query the data sources 10 switch to another channel which, however, is always the same for all data sources 10 of the system. In this regard, provision can be made whereby after an n-fold switch of communications channels the data sources 10 resort to the original first channel, with the result that one can refer to this as an n-fold periodicity of the utilized communications channels.

A point which must be kept in mind in regard to all embodiment variants described here is that the technical features designated in connection with one embodiment can be employed not only in the specifically designated embodiment, but also in various other here-designated or possible embodiments of the invention. All disclosed technical features of this entire invention description must be classified as essential to the invention and are applicable in any combination with each other or in their own right.

1. A data-exchange process comprising the steps of:
a) periodically broadcasting at predetermined first short intervals from each of a plurality of data sources on a radio channel a communication-initiating radio signal indicating that the respective source has data ready for transfer;
b) monitoring the radio channel with a receiver;
c) transmitting from the receiver to one of the sources a signal triggering data exchange and subsequently transmitting the respective data from the one source to the receiver; and
d) thereafter suspending periodic broadcast of the communication-initiating radio signal from the one source on the radio channel for a predetermined long interval substantially greater than the short interval.

2. The data-exchange process defined in claim 1 wherein the long interval is equal to at least a multiple of the short interval.

3. The data-exchange process defined in claim 1, further comprising the steps after step d) of
e) transmitting from the receiver to another of the sources a signal triggering data exchange and subsequently transmitting the respective data from the other source to the receiver; and
f) thereafter suspending periodic transmission of the communication-initiating radio signal from the other source for a predetermined long interval substantially greater than the short interval.

4. The data-exchange process defined in claim 1, further comprising the step after step d) of:
e) recommencing broadcast of the communication-initiating signals from the one source.

5. The data-exchange process defined in claim 4 wherein the broadcast of step e) is effected on a radio channel different from the radio channel on which the broadcast of step a) and the transfer of step c) were effected.

6. The data-exchange process defined in claim 5 wherein each source, after completing step c) switches to an alternate channel for the next broadcast and data transfer.

7. The data-exchange process defined in claim 1 wherein the sources are devices for measuring usage or a resource.

8. The data-exchange process defined in claim 7 wherein the resource is electricity, heat, gas, or water.

9. The data-exchange process defined in claim 1 wherein the sources are fire or smoke detectors.

10. The data-exchange process defined in claim 1 wherein at the start of step c) the receiver directs the one source to switch to another radio channel for the exchange of data.

11. The data-exchange system comprising:
a plurality of sources each having means for periodically broadcasting at predetermined first short intervals on a radio channel a communication-initiating radio signal indicating that the respective source has data ready for transfer;
a receiver having means for;
monitoring the radio channel with a receiver, and
transmitting from the receiver to one of the sources a signal triggering data exchange and subsequently transmitting the respective data from the one source to the receiver
the sources each having means for suspending periodic broadcast on the radio channel of the communication-initiating radio signal from the one source for a predetermined long interval substantially greater than the short interval after data transfer to the receiver.

12. The data-exchange system defined in claim 11 wherein the sources are utility-consumption meters.
